(19) United States
(12) Patent Application Publication
(10) Pub. No.: US 2002/0174249 A1
(43) Pub. Date: Nov. 21, 2002

(54) Matrix network control system & matrix naming structure

(76) Inventor: Derrick T. Babb, Winter Park, FL (US)

Correspondence Address: DERRICK T. BABB, 1000 HOLT AVENUE, WINTER PARK, FL, 32789, US

(21) Appl. No.: 09/681,519

(22) Filed: Apr. 22, 2001

(51) Int. Cl. G06F 15/16

(52) U.S. Cl. 709/245

(57) ABSTRACT

This patent application covers the invention of a new network architecture designed to power the Internet. It represents a new design for developing information and communication networks as well as their integration with one another and network users.

### BACKGROUND OF INVENTION

Matrix Network Control System, or “The Matrix”

Development of the first Matrix Implementation (Matrixlmpl) began the Summer of 2000. Since then the Matrix Network ControlSystem, founded upon the Matrix Naming Structure, from which its name is derived, has been developed into a fully featured softwarearchitecture that will be used to replace the Domain Naming System that currently powers the Internet and evolve the Internet into an even more powerful tool; setting a new standard by which to develop and connect the many diverse networks and users of the world.

The Matrix was initially designed as a replacement for the Domain Naming System (DNS). The Matrix Naming Structure is the replacement of the limited DNS naming architecture itself. The Matrix Network Control System is the other half of the equation, a functional network using the naming structure.

DNS provides a one-dimensional naming structure that is predominately used to translate domain names and sub-domain names into Internet Protocol addresses. It uses categories such as .com, .net, .edu, .gov, .au, .jp, etc. combined with an alphanumeric identification to produce a domain name (i.e. conquerware.com).

One of the primary limitations of DNS is the limited amount of “practicable” domain names available; even with the creation of new categories such as “.tv.”

The Matrix introduces a “two-dimensional naming structure” designed using the concept of a mathematical matrix. The Matrix makes possible the existence of more than one of an identical identification, located on differing matrices.

[t2]

[Matrix Naming Structure]

| Identification | Matrix |
|---|---|
| dbabb | . . . |
| dbabb | 21 |
| dbabb | 22 |
| dbabb | 23 |
| dbabb | . . . |
| dbabb | 9998 |
| dbabb | 9999 |
| dbabb | 10000 |
| dbabb | . . . |

dbabb 21 “dbabb on the 21^{st} Matrix”, dbabb 110 “dbabb on the 110^{th} Matrix”, etc.; a two-dimensional naming structure, versus the one-dimensional structure DNS provides.

Furthermore, with the Matrix you are not confined by a limited set of categories or regional separations such as you are with DNS. In the beginning the Global Matrix (GM), the highest component of the Matrix Network Control System, will contain matrices 0 through 10,000. Thus, if the technology lives up to its potential, it will provide an enormous benefit to both users and organizations on its expanded naming structure alone.

Another important point, DNS only allows letters, numbers, and the hyphen. The Matrix allows for the use of all characters, including spaces. In fact, the Matrix is being designed to utilize the Unicode Standard, allowing for complete multi-lingual integration; with the capability of representing identifications and matrices in a user's native language. In the Global Matrix the same 10,000 matrices will exist across all languages, and contain all root definitions, regardless of what language they exist in. The Matrixlmpl is being designed so that it will be able to recognize the numeric identification of a matrix within a native language Matrix Identification (MID), translate it, and place the definition with the proper matrix.

The Matrix has been designed to overcome many of DNS's limitations in terms of a naming system, and introduce many new features and capabilities for network developers and users.

The Matrix is composed of Matrix Objects, and every Matrix Object is represented by a Matrix Identification. The second part of this patent covers developing a network, composed of objects, identified by a name devised using the Matrix Naming Structure.

With the protection this patent will provide for both the invented process of the Matrix Naming Structure (further outlined in subsequent sections) and its implementation as a base for developing a network it will be possible to make the effort of introducing and implementing the technology into the mainstream without fear of the idea being stolen by another organization.

The Matrix is a “Network Control System.” It will provide an end-to-end architecture that can be used to connect every communication and information system in the world, across all languages and borders.

### DETAILED DESCRIPTION

The Matrix Network Control System (MNCS), “The Matrix,” is an elaborately designed softwarearchitecture built on the Matrix Naming Structure, designed to connect all the communication and information systems of the world, across all languages and borders, and power the Internet in the 21^{st} century.

[Matrix Naming Structure]

The Matrix is formed of matrices, represented by numbers, letters or an alphanumeric combination, such as “21,”“Earth, ”or “21E”. In practice the matrices will only be represented by numbers, but the time may come where expansion requires the presence of a letter or the integration of the current DNS system and its categories; so the possibility of using letters or alpha-numeric combinations is included within the scope of this patent application.

Within a matrix root definitions are created. A root definition can represent either an organization (ConquerWare) or an individual (dbabb). The name of the organization or individual combines with the matrix representation (i.e. “21”) to form the root definition (i.e. ConquerWare 21, dbabb 21, or adumas 1802). The root definition is a Matrix Identification, or MID. Branches and aliases can be created under a root definition, separated by the “|” and “@” characters, respectively. Here are some examples of MIDs:

ConquerWare 21

Global Matrix|ConquerWare 21

Southeast Server Group|North America|Global Matrix|ConquerWare 21

The Matrix @ ConquerWare 21

dbabb 21

Derrick Babb 1980

[Matrix Network Control System]

The Matrix is formed of objects, Matrix Objects. Every Matrix Object is represented by its own unique Matrix Identification; formed using the Matrix Naming Structure .

The Matrix is powered by the GM, the Global Matrix, that handles all root definitions. Internally the Matrixlmpl includes a built-in distribution structure providing for data-redundancy and load balancing, an end to end authentication schema, a “Service Manager” that uses simple data types, an advanced low-level communication module called the “Interlink”, and “Streamline”, a real-time code distribution and activation module.

With the completion of the first MatrixImpl, the distribution schema of the Global Matrix will be expanded to provide true global distribution and redundancy. One point of design is allowing users and organizations to specify their region of primary operation, and distribute their primary matrix object within the specified region, with secondary objects distributed redundantly throughout the world. Thus, if a region is separated from rest the Internet and Global Matrix, operation can continue within the primary region unaffected. A similar design has already been applied to allow for the distribution of root definitions on separated MatrixImpls, addressing the issue of companies and users being separated from the GM.

The Matrix was designed using simple data types, setting the stage for development of native implementations, a CORBA interface, and other factory standard integration. The Matrix has been designed to be completely adaptable and integrate able with both existing and future technologies and standards of the world.

While the first MatrixImpl is constructed to operate in English, the project is designed for multi-lingual operation. It will soon be possible to represent a Matrix Object in any language supported by the Unicode Standard.

1. I claim the matrix network control system and matrix naming structure outlined in this patent as my invention:
The Matrix Naming Structure specifically includes creating a matrix, a collective structure containing sub-objects, that is represented by number(s), letters(s) or an alpha-numeric combination, separated by a space, then combined with an identifying name, number, or alpha-numeric combination to form a root definition. The naming structure also includes developing branches using the “|” character and using the “@” character to form aliases. The Matrix Network Control System specifically includes developing a network structure using the Matrix Naming Structure, including the development of the Global Matrix.
